(19) United States
(12) Patent Application Publication
(10) Pub. No.: US 2010/0239272 A1
(43) Pub. Date: Sep. 23, 2010

(54) DEVELOPING DEVICE AND IMAGE FORMING APPARATUS

(75) Inventors: Takamasa IKAGAWA, Shiojiri-shi (JP); Makoto SATO, Matsumoto-shi (JP); Takatomo FUKUMOTO, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/722,218

(22) Filed: Mar. 11, 2010

(30) Foreign Application Priority Data
Mar. 23, 2009 (JP) 2009-070168

(51) Int. Cl. G03G 15/08

(52) U.S. Cl. 399/27

(57) ABSTRACT

A developing device includes: a developer carrier configured to carry toner; a toner supply member configured to supply developer to the developer carrier; a developing chamber having the developer carrier and the toner supply member; and a sensing device disposed above a toner level in the developing chamber and configured to sense a toner flow.

### BACKGROUND

1. Technical Field

The present invention relates to a developing device for electronic photographs and an image forming apparatus.

2. Related Art

In the related art, there is an apparatus provided with a light-projecting unit and a light-receiving unit provided in a toner storage chamber, and configured to detect the fact that a predetermined toner is stored in the toner storage chamber by detecting that light proceeding from the light-projecting unit to the light-receiving unit is interrupted by toner. Also, there is an apparatus provided with a cleaning member configured to pass through a space between the light-projecting unit and the light-receiving unit and come into sliding contact with the light-projecting unit and the light-receiving unit for cleaning the same in the toner storage chamber (JP-A-2008-203378).

However, in the related art, since a sensor for detecting a toner level senses the toner level by the fact that the height of the toner level exceeds the height of the sensor position, there is a case of being affected by a local toner level. In addition, in order to allow the cleaning member to pass through the space between the light-projecting unit and the light-receiving unit for cleaning, it is necessary to cause the cleaning member to rotate at high speeds and remove the toner present therebetween.

### SUMMARY

An advantage of some aspects of the invention is to provide a developing device having high degree of sensing accuracy and high degree of durability and an image forming apparatus.

According to a first aspect of the invention, there is provided a developing device including: a developer carrier configured to carry toner; a toner supply member configured to supply developer to the developer carrier; a developing chamber having the developer carrier and the toner supply member; and a sensing device disposed above a toner level in the developing chamber and configured to sense a toner flow. In this configuration, the developing device having high degree of sensing accuracy and high degree of durability is provided.

Preferably, a splash-up member configured to form a toner flow splashing upward by causing the toner in the developing chamber to flow is provided. In this configuration, the splash-up toner flow is easily formed.

Preferably, the splash-up member is a wall portion of the developing chamber, the low cost and the weight reduction are enabled by using an existing member.

Preferably, the splash-up member is a roller disposed out of an image forming area, turbulence of the toner flow stored in the developing chamber is reduced, and a toner film of a developing roller formed by the toner being supplied from a toner supply roller is formed uniformly.

Preferably, a sensing device cleaning unit configured to clean a sensing unit of the sensing device is provided. In this configuration, improvement of the accuracy of the sensing device is achieved.

Preferably, a toner flow restraining member configured to restrain the toner flow is provided below the sensing device. In this configuration, probability of the splash-up toner flow on a portion other than the sensing unit is reduced.

Preferably, the sensing device determines the toner level from a time length when the toner flow is sensed during a predetermined period, so that the toner level is determined easily.

According to the second aspect of the invention, image forming apparatus includes at least: a latent image carrier on which an electrostatic latent image is formed; a developing device configured to develop the electrostatic latent image and form an image on the latent image carrier; a transfer unit configured to transfer the image on the latent image carrier, in which the developing device is mounted. In this configuration, satisfactory image formation is achieved.

### BRIEF DESCRIPTION OF THE DRAWINGS

The invention will be described with reference to the accompanying drawings wherein like numbers reference like elements.

FIG. 1 is a drawing showing an image forming apparatus according to an embodiment.

FIG. 2 is a cross-sectional view showing a periphery of a photosensitive member and principal components of a developing cartridge.

FIG. 3 is a schematic drawing of a developing cartridge 50Y in a direction orthogonal to an axis thereof.

FIG. 4 is a drawing similar to FIG. 3 viewed in a direction indicated by an arrow.

FIGS. 5A to 5C are drawings showing a case in which a toner level T1 is slightly lower than a light-emitting surface 151aY and a light-receiving surface 152aY.

FIGS. 6A to 6C are drawings showing a case in which the toner level T1 is at a predetermined height which is lower than the light-emitting surface 151aY and the light-receiving surface 152aY.

FIGS. 7A to 7C are drawings showing a case in which the toner level T1 is lower than that in FIGS. 6A to 6C.

FIG. 8 is a drawing showing a state in which a toner level sensor 150Y is always in an ON state.

FIG. 9 is a drawing showing a state in which the toner level sensor 150Y is always in an OFF state.

FIG. 10 is a drawing showing a second embodiment.

FIG. 11 is a drawing showing a third embodiment.

FIG. 12 is a drawing showing a fourth embodiment.

FIG. 13 is a drawing showing a state in which the toner level sensor 150Y and a toner level sensor cleaning unit 155Y are disposed in the opposite direction from those in the first embodiment.

FIGS. 14A to 14C are drawings showing a related art.

### DESCRIPTION OF EXEMPLARY EMBODIMENTS

Referring now to drawings, embodiments of the invention will be described below.

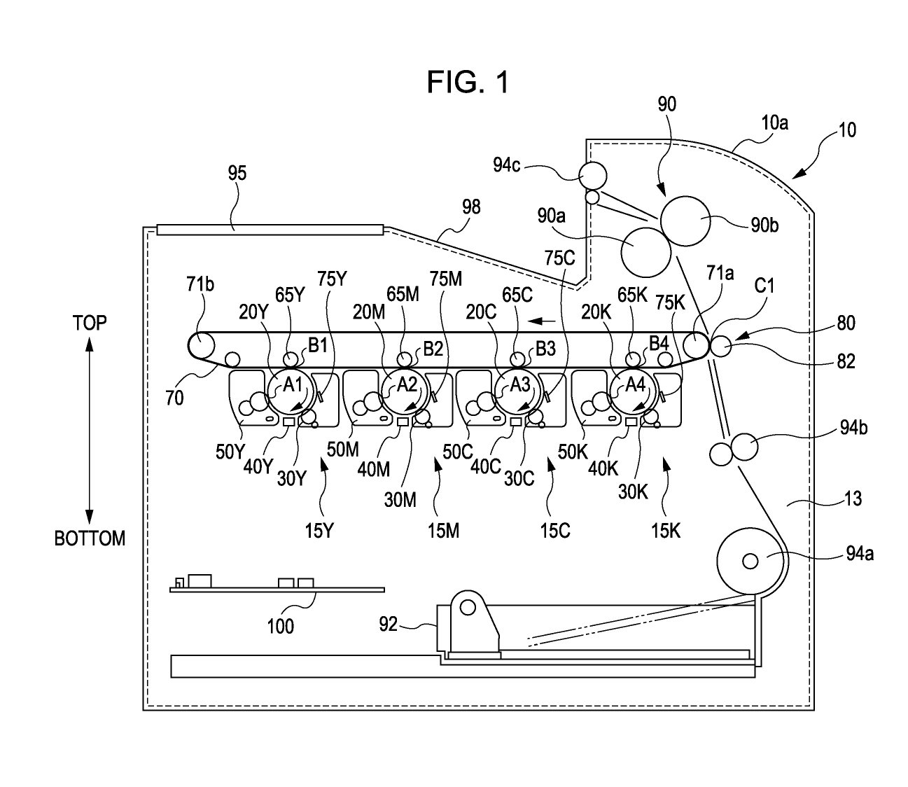

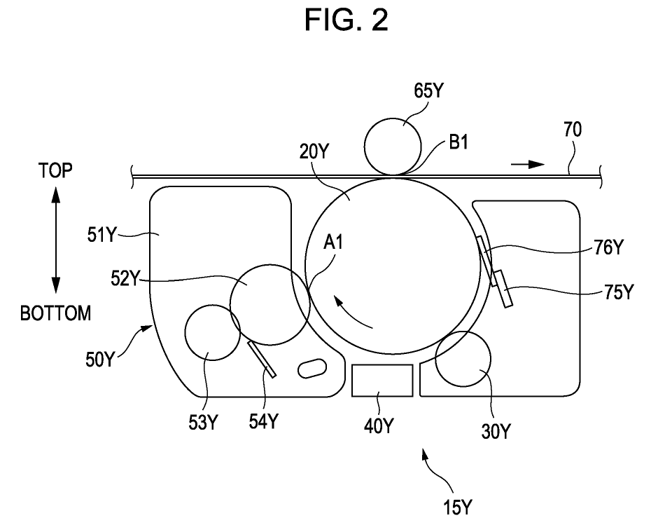

FIG. 1 is a drawing showing an embodiment of an image forming apparatus provided with a developing device according to the invention, and FIG. 2 is an enlarged view of an yellow image forming station shown in FIG. 1.

As shown in FIG. 1, an image forming apparatus 10 includes four image forming stations 15 (Y, M, C, K), an intermediate transfer belt 70, and a secondary transfer unit 80 and, in addition, a fixing unit 90, a display unit 95 which serves as a notification device for users and made up of a liquid crystal panel, and a control unit 100 as a controller configured to control these units and controls an operation as the image forming apparatus.

The image forming stations 15 (Y, M, C, K) respectively have functions to form images of toners of yellow (Y), magenta (M), cyan (C), and black (K). Since the configurations of the image forming stations 15 (Y, M, C, K) are the same, an image forming station 15Y will be described in the description below.

The image forming station 15Y includes a charging unit 30Y, an exposing unit 40Y, a developing cartridge 50Y as the developing device, a primary transfer unit B1, and a photosensitive member cleaning unit 75Y along the direction of rotation of a photosensitive member 20Y as an example of a latent image carrier as shown in FIG. 2.

The photosensitive member 20Y includes a cylindrical base member and a photosensitive layer formed on an outer peripheral surface thereof, is rotatable about a center axis thereof, and rotates clockwise as indicated by an arrow in this embodiment.

The charging unit 30Y is a device configured to charge the photosensitive member 20Y. A latent image is formed on the photosensitive member 20Y charged by being irradiated with a laser from the exposing unit 40Y.

The exposing unit 40Y includes a semiconductor laser, a polygon mirror, and an F-θ lens and irradiates the charged photosensitive member 20Y with a modulated laser on the basis of an image signal supplied from a host computer, not shown, such as a personal computer, or a word processor.

The developing cartridge 50Y is a device configured to develop a latent image formed on the photosensitive member 20Y using toner in yellow (Y). The developing cartridge 50Y includes a developing roller 52Y as a developer carrier, and a toner supply roller 53Y as a toner supply member in a developing chamber 51Y to which new toner is supplied from a replaceable toner cartridge, not shown. A restraining blade 54Y as a restraining member comes into abutment with the developing roller 52Y to make the toner on the developing roller 52Y into a thin layer.

The restraining blade 54Y is arranged above or below the developing roller 52Y, and is configured to restrain the amount of toner to be carried by the developing roller 52Y. When the restraining blade 54Y is provided below the developing roller 52Y so as to come into abutment therewith in an opposite direction with respect to the direction of rotation of the developing roller 52Y, toner passed through a nip between the developing roller 52Y and the toner supply roller 53Y is allowed to drop on a lower transport path 55bY further easily.

The primary transfer unit B1 is configured to transfer an yellow toner image formed on the photosensitive member 20Y to the intermediate transfer belt 70. When toners in four colors are transferred on top of another in sequence by respective primary transfer units B1, B2, B3, and B4, a full-color toner image is formed on the intermediate transfer belt 70.

The intermediate transfer belt 70 is an endless belt wound tightly between a belt drive roller 71a and a driven roller 71b, and is driven to rotate while in abutment with photoreceptors 20 (Y, M, C, K).

The secondary transfer unit 80 is a device configured to transfer a single-color toner image or a full-color toner image formed on the intermediate transfer belt 70 to a transfer member such as paper, film, or cloth.

The fixing unit 90 is made up of a fixing roller 90a and a pressurizing roller 90b, and is a device configured to cause the single-color toner image and the full-color toner image transferred to the transfer member to be fusion-bonded as a permanent image.

The photosensitive member cleaning unit 75Y includes a rubber-made photosensitive member cleaning blade 76Y being brought into abutment with the surface of the photosensitive member 20Y, and is a device configured to scrape and remove toner remaining on the photosensitive member 20Y by the photosensitive member cleaning blade 76Y after having transferred the toner image on the intermediate transfer belt 70 by the primary transfer unit B1.

Subsequently, an operation of the image forming apparatus 10 configured in this manner will be described.

First of all, when an image signal and a control signal from the host computer, not shown is supplied to a main controller of the image forming apparatus via an interface, the photosensitive member 20Y, the developing roller 52Y and the supply roller 53Y provided in the developing cartridge 50Y and the intermediate transfer belt 70 rotates by control of the unit controller on the basis of a command from the main controller. The photosensitive member 20Y is charged by the charging unit 30Y at a charging position while rotating.

A charged area on the photosensitive member 20Y reaches an exposing position in association with the rotation of the photosensitive member 20Y, and a latent image according to the image information in yellow Y is formed in the corresponding area by the exposing unit 40Y.

The latent image formed on the photosensitive member 20Y reaches a developing position in association with the rotation of the photosensitive member 20Y, and is developed by the developing cartridge 50Y. Accordingly, a toner image is formed on the photosensitive member 20Y.

The toner image formed on the photosensitive member 20Y reaches the position of the primary transfer unit B1 in association with the rotation of the photosensitive member 20Y, and is transferred to the intermediate transfer belt 70 by the primary transfer unit. In this case, a primary transfer voltage having a polarity opposite from the charged polarity of the toner is applied to the primary transfer unit. Consequently, the toner images in four colors formed on the respective photoreceptors 20 (Y, M, C, K) are transferred to the intermediate transfer belt 70 on top of another, so that a full-color toner image is formed on the intermediate transfer belt 70.

The intermediate transfer belt 70 is driven by a drive force from a belt drive unit such as a motor being transmitted via the belt drive roller 71a.

The full-color toner image formed on the intermediate transfer belt 70 is transferred to a transfer member such as paper by the secondary transfer unit 80. The transfer member as such is transported from a paper-feed tray to the secondary transfer unit 80 via a paper feed roller 94a and a registration roller 94b.

The full-color liquid developer image transferred to the transfer member is heated and pressurized and hence fusion-bonded to the transfer member by the fixing unit 90. After having passed through the fixing unit 90, the transfer member is discharged by a paper discharging roller 94c.

In contrast, the photoreceptors 20 (Y, M, C, K) are diselectified by a diselectrifying unit (not shown) after having passed through the primary transfer units B1, B2, B3, and B4, then are scraped off with toner adhered on the surfaces thereof by photosensitive member cleaning blades 76 (Y, M, C, K) supported by photosensitive member cleaning units 75 (Y, M, C, K) to be ready for charging for forming the next latent images. The scraped toners are collected in remaining toner collecting units provided on the photosensitive member cleaning units 75 (Y, M, C, K).

An intermediate transfer belt cleaning apparatus (not shown) is arranged on the side of the driven roller 71b of the intermediate transfer belt 70 after the secondary transfer, and cleans the intermediate transfer belt 70 after the secondary transfer. Although the embodiment of an intermediate transfer system using the intermediate transfer belt has been described, it may be an image forming apparatus of a direct transfer system.

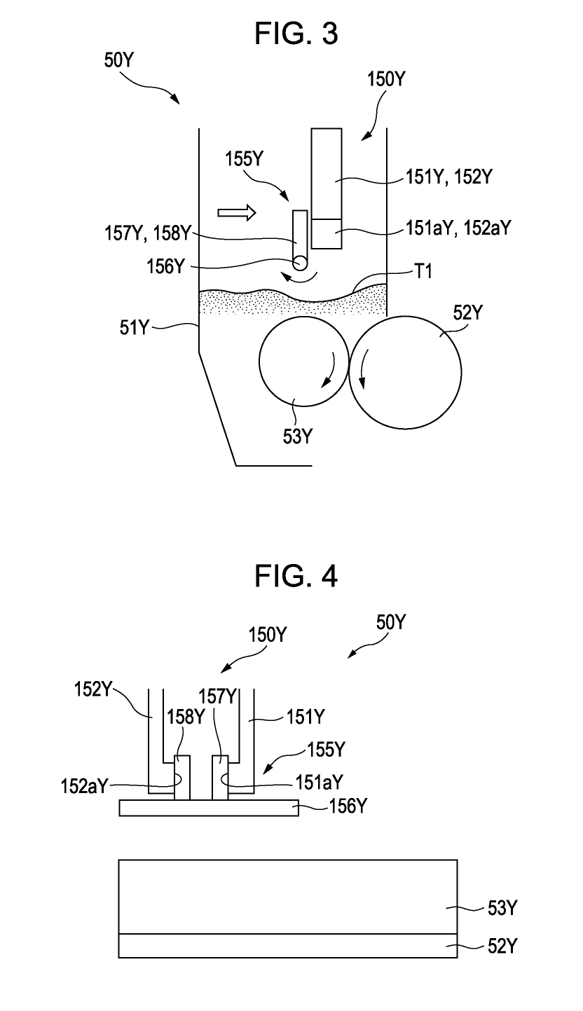

Subsequently, a toner level sensor 150Y as a sensing device in the developing chamber 51Y of the developing cartridge 50Y in this embodiment will be described. FIG. 3 is a schematic drawing of the developing cartridge 50Y in a direction orthogonal to the axis thereof, and FIG. 4 is a drawing viewed in the direction indicated by an arrow in FIG. 3.

The toner level sensor 150Y is disposed in the developing chamber 51Y of the developing cartridge 50Y above the developing roller 52Y and the toner supply roller 53Y. The toner level sensor 150Y includes a light-emitting unit 151Y and a light-receiving unit 152Y. The light-emitting unit 151Y includes a light-emitting surface 151aY emitting light. The light-receiving unit 152Y includes a light-receiving surface 152aY configured to receive light emitted from the light-emitting surface 151aY. The light-emitting surface 151aY and the light-receiving surface 152aY are disposed so as to oppose with respect to the direction of axes of the developing roller 52Y and the toner supply roller 53Y. The toner level sensor 150Y senses the presence of the toner by the light emitted from the light-emitting surface 151aY not being received by the light-receiving surface 152aY and produces an output of an ON signal. The toner level sensor 150Y senses the absence of the toner by the light emitted from the light-emitting surface 151aY being received by the light-receiving surface 152aY and produces an output of an OFF signal.

In the proximity of the toner level sensor 150Y in the developing chamber 51Y, a toner level sensor cleaning unit 155Y as a sensing device cleaning unit is provided. The toner level sensor cleaning unit 155Y includes a revolving shaft 156Y extending in parallel with the directions of the axes of the developing roller 52Y and the toner supply roller 53Y and a line connecting the light-emitting surface 151aY and the light-receiving surface 152aY of the toner level sensor 150Y, a light-emitting surface cleaning member 157Y attached to the revolving shaft 156Y and configured to rotate with the revolving shaft 156Y, and a light-receiving surface cleaning member 158Y. The light-emitting surface cleaning member 157Y comes into sliding contact with the light-emitting surface 151aY and the light-receiving surface cleaning member 158Y comes into sliding contact with the light-receiving surface 152aY to clean the same, respectively.

Subsequently, operations of the toner level sensor 150Y and the toner level sensor cleaning unit 155Y will be described.

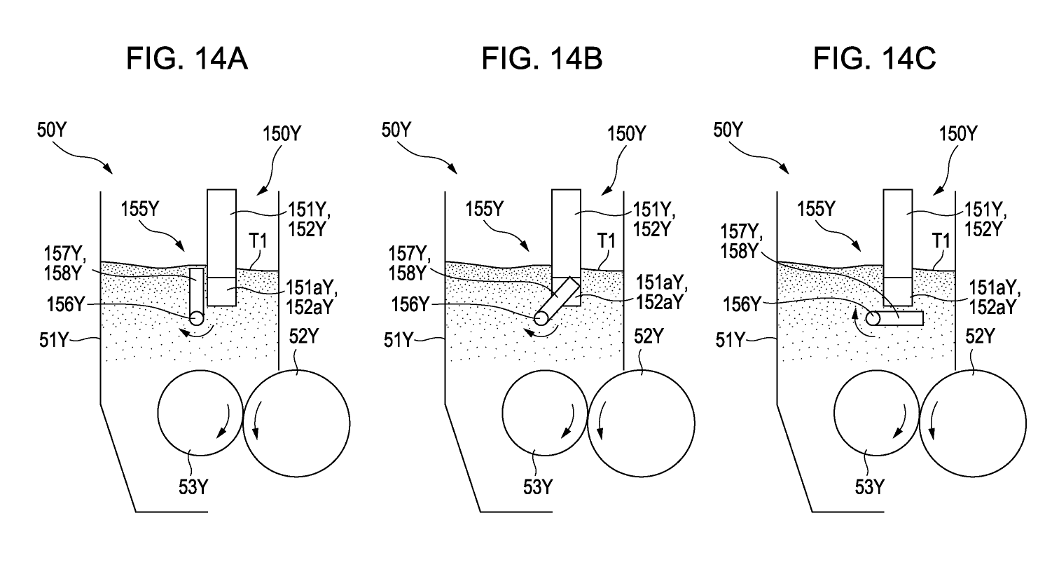

First of all, operations of the toner level sensor 150Y and the toner level sensor cleaning unit 155Y in the related art will be described. FIG. 14 shows a related art, and is a drawing showing a case in which a toner level T1 is higher than the light-emitting surface 151aY and the light-receiving surface 152aY.

In the state shown in FIG. 14A, the light-emitting surface cleaning member 157Y and the light-receiving surface cleaning member 158Y do not interrupt the light-emitting surface 151aY and the light-receiving surface 152aY, but the light-emitting surface 151aY and the light-receiving surface 152aY are interrupted by the toner, the toner level sensor 150Y is turned ON.

In the state shown in FIG. 14B, the light-emitting surface cleaning member 157Y and the light-receiving surface cleaning member 158Y interrupt the light-emitting surface 151aY and the light-receiving surface 152aY, the toner level sensor 150Y is turned ON.

In the state shown in FIG. 14C, the light-emitting surface cleaning member 157Y and the light-receiving surface cleaning member 158Y do not interrupt the light-emitting surface 151aY and the light-receiving surface 152aY, but the light-emitting surface 151aY and the light-receiving surface 152aY are interrupted by the toner, the toner level sensor 150Y is turned ON.

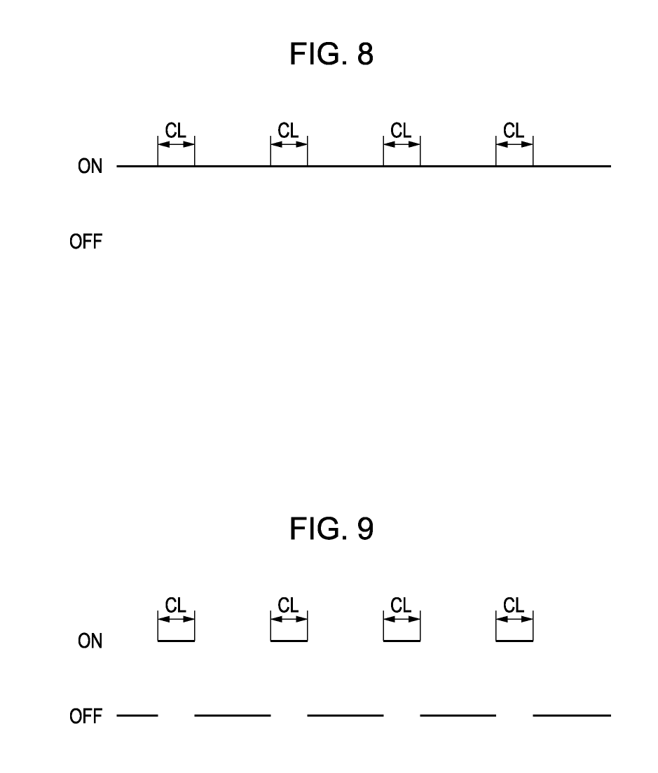

Therefore, when the toner level T1 is higher than the light-emitting surface 151aY and the light-receiving surface 152aY, the toner level sensor 150Y is constantly in the ON state as shown in FIG. 8, described later.

Subsequently, operations of the toner level sensor 150Y and the toner level sensor cleaning unit 155Y in this embodiment will be described.

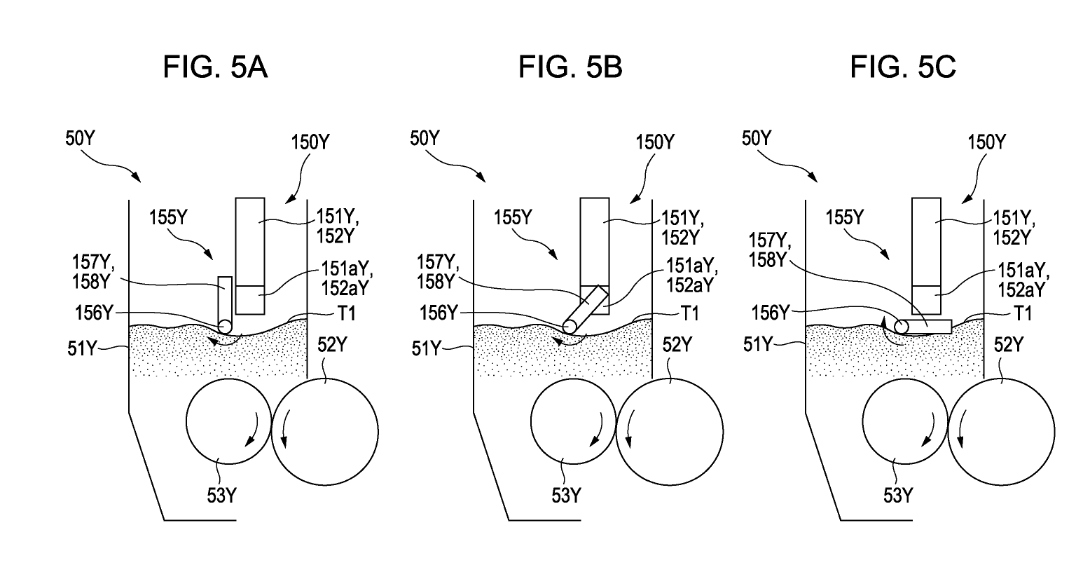

FIGS. 5A to 7C are drawings showing operating states of the toner level sensor 150Y and the toner level sensor cleaning unit 155Y in different toner levels T1, and FIGS. 8 and 9 are drawings showing ON/OFF states of the toner level sensor 150Y.

FIGS. 5A to 5C are drawings showing a case in which the toner level T1 is slightly lower than the light-emitting surface 151aY and the light-receiving surface 152aY. In the states shown in FIGS. 5A to 5C, since the toner level is positioned above the developing roller 52Y and the toner supply roller 53Y, a force of a toner flow is not strong in the vicinity of the surface of the toner level T1 even when the developing roller 52Y and the toner supply roller 53Y are activated.

In the state shown in FIG. 5A, the light-emitting surface cleaning member 157Y and the light-receiving surface cleaning member 158Y do not interrupt the light-emitting surface 151aY and the light-receiving surface 152aY, the toner level sensor 150Y is turned OFF.

In the state shown in FIG. 5B, the light-emitting surface cleaning member 157Y and the light-receiving surface cleaning member 158Y interrupt the light-emitting surface 151aY and the light-receiving surface 152aY, the toner level sensor 150Y is turned ON.

In the state shown in FIG. 5C, the light-emitting surface cleaning member 157Y and the light-receiving surface cleaning member 158Y do not interrupt the light-emitting surface 151aY and the light-receiving surface 152aY, the toner level sensor 150Y is turned OFF.

Therefore, when the toner level T1 is slightly lower than the light-emitting surface 151aY and the light-receiving surface 152aY, the toner level sensor 150Y repeats ON and OFF as shown in FIG. 9.

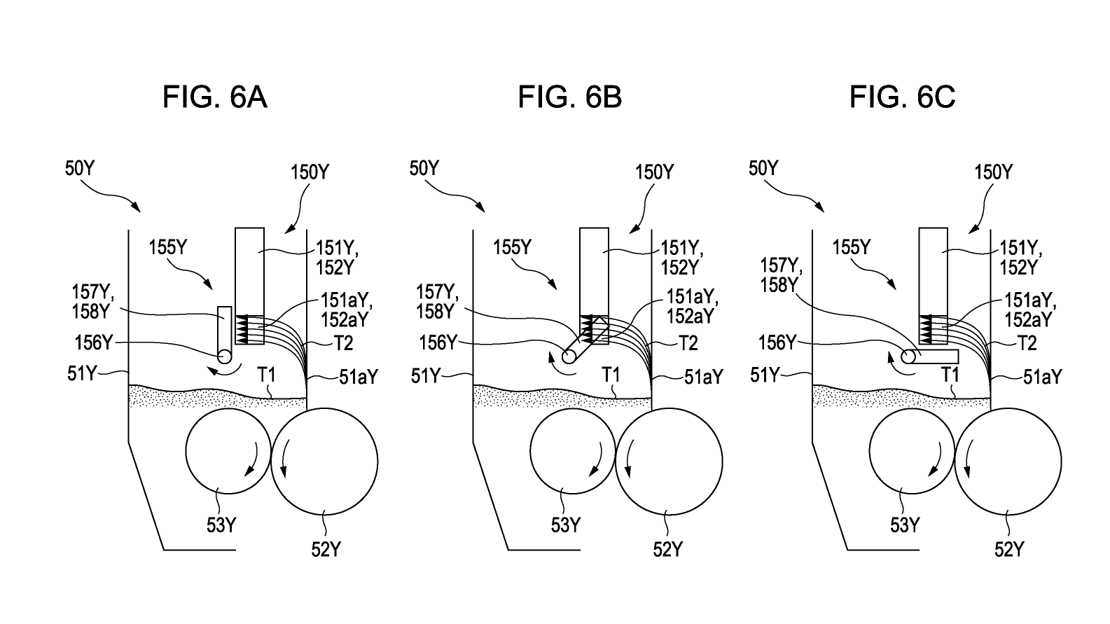

FIGS. 6A to 6C are drawings showing a case in which the toner level T1 is at a predetermined height which is lower than the light-emitting surface 151aY and the light-receiving surface 152aY. In the states shown in FIGS. 6A to 6C, the toner present above the developing roller 52Y and the toner supply roller 53Y is smaller than the state shown in FIGS. 5A to 5C. In the case of this embodiment, in the developing chamber 51Y, when the developing roller 52Y and the toner supply roller 53Y are operated, a force of the toner flow becomes stronger than the state shown in FIGS. 5 A to 5C in association with the operation of the developing roller 52Y and the toner supply roller 53Y in the vicinity of the surface of the toner level T1. As shown in FIGS. 6A to 6C, when the toner level T1 is at a predetermined height, the flowed toner collides a wall portion 51aY as a splash-up member in the developing chamber 51Y so that a toner flow T2 reversed and splashed up is generated. The toner flow T2 is splashed up to the level of the light-emitting surface 151aY and the light-receiving surface 152aY. The toner flow T2 is generated only when the distance between the toner supply roller 53Y and the toner level T1 is a predetermined distance which causes a toner flow with great momentum near the surface of the toner level T1, and is not generated if the toner level T1 is lower or higher than that.

In the state shown in FIG. 6A, the light-emitting surface cleaning member 157Y and the light-receiving surface cleaning member 158Y do not interrupt the light-emitting surface 151aY and the light-receiving surface 152aY, but the light-emitting surface 151aY and the light-receiving surface 152aY are interrupted by the toner flow T2, the toner level sensor 150Y is turned ON.

In the state shown in FIG. 6B, the light-emitting surface cleaning member 157Y and the light-receiving surface cleaning member 158Y interrupt the light-emitting surface 151aY and the light-receiving surface 152aY, the toner level sensor 150Y is turned ON.

In the state shown in FIG. 6C, the light-emitting surface cleaning member 157Y and the light-receiving surface cleaning member 158Y do not interrupt the light-emitting surface 151aY and the light-receiving surface 152aY, but the light-emitting surface 151aY and the light-receiving surface 152aY are interrupted by the toner flow T2, the toner level sensor 150Y is turned ON.

Therefore, when the toner level T1 is a predetermined height lower than the light-emitting surface 151aY and the light-receiving surface 152aY, the toner level sensor 150Y is constantly in the ON state as shown in FIG. 8.

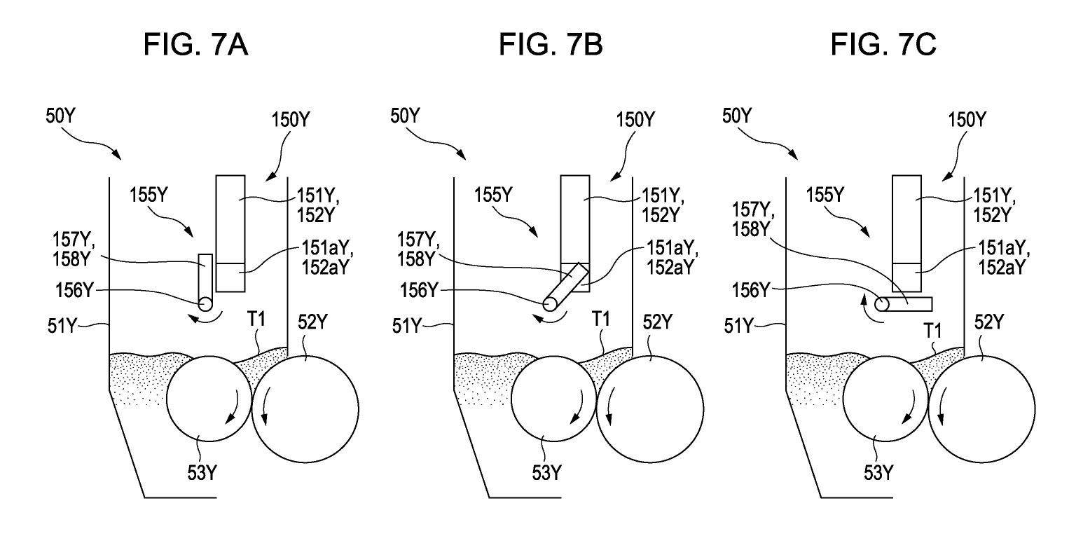

FIGS. 7A to 7C are drawings showing a case in which the toner level T1 is lower than that in FIGS. 6A to 6C. In the state shown in FIGS. 7A to 7C, part of the surface of the toner supply roller 53Y is exposed from the toner level T1.

In the states shown in FIG. 7A, the light-emitting surface cleaning member 157Y and the light-receiving surface cleaning member 158Y do not interrupt the light-emitting surface 151aY and the light-receiving surface 152aY, the toner level sensor 150Y is turned OFF.

In the state shown in FIG. 7B, the light-emitting surface cleaning member 157Y and the light-receiving surface cleaning member 158Y interrupt the light-emitting surface 151aY and the light-receiving surface 152aY, the toner level sensor 150Y is turned ON.

In the state shown in FIG. 7C, the light-emitting surface cleaning member 157Y and the light-receiving surface cleaning member 158Y do not interrupt the light-emitting surface 151aY and the light-receiving surface 152aY, the toner level sensor 150Y is turned OFF.

Therefore, when the toner level T1 is lower than that in FIGS. 6A to 6C, the toner level sensor 150Y repeats ON and OFF as shown in FIG. 9.

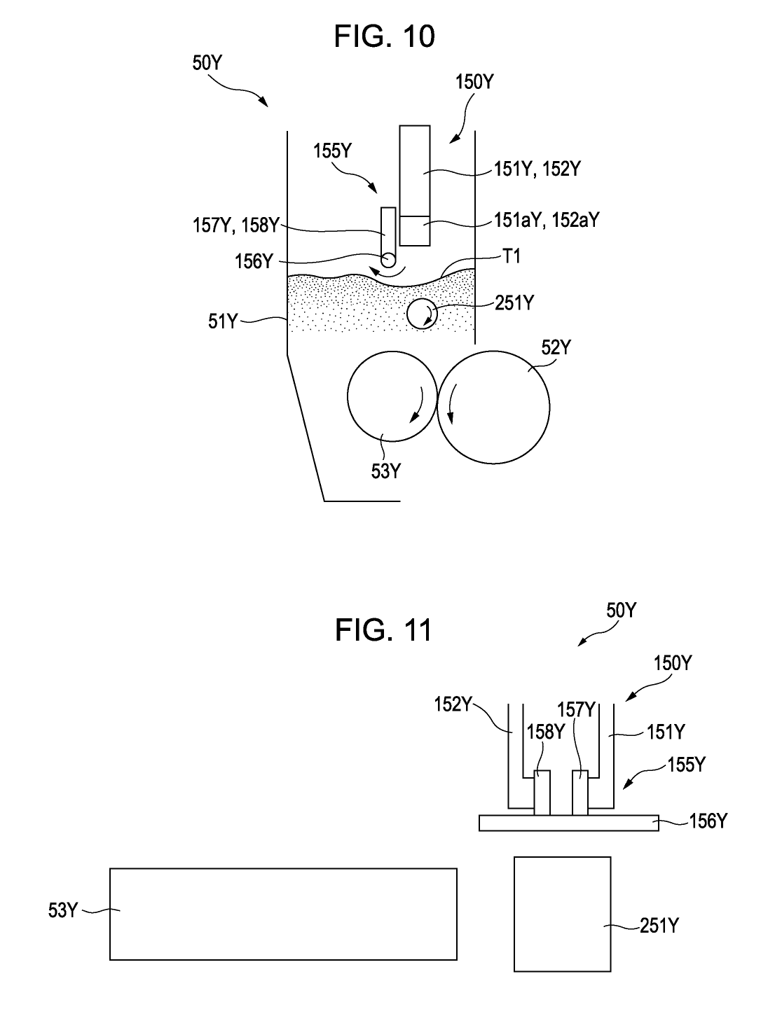

FIG. 10 is a drawing showing a second embodiment. In the second embodiment, a toner flow generating roller 251Y as the splash-up member is provided. The toner flow generating roller 251Y is disposed above the developing roller 52Y and the toner supply roller 53Y, and below the toner level sensor 150Y and the toner level sensor cleaning unit 155Y. Then, when the toner flow generating roller 251Y is operated, the toner flow T2 is generated.

FIG. 11 is a drawing showing a third embodiment. In the third embodiment, the toner level sensor 150Y, the toner level sensor cleaning unit 155Y, and the toner flow generating roller 251Y provided in the second embodiment are provided outside an image forming area P. In particular, by disposing the toner flow generating roller 251Y outside the image forming area P, turbulence of the toner flow stored in the developing chamber 51Y is reduced, and a toner film of the developing roller 52Y formed by the toner being supplied from the toner supply roller 53Y is formed uniformly. It is preferable to configure the toner flow generating roller 251Y to be coaxially with the toner supply roller 53Y and drives the same by the same drive member in terms of the downsizing or cost reduction of the device.

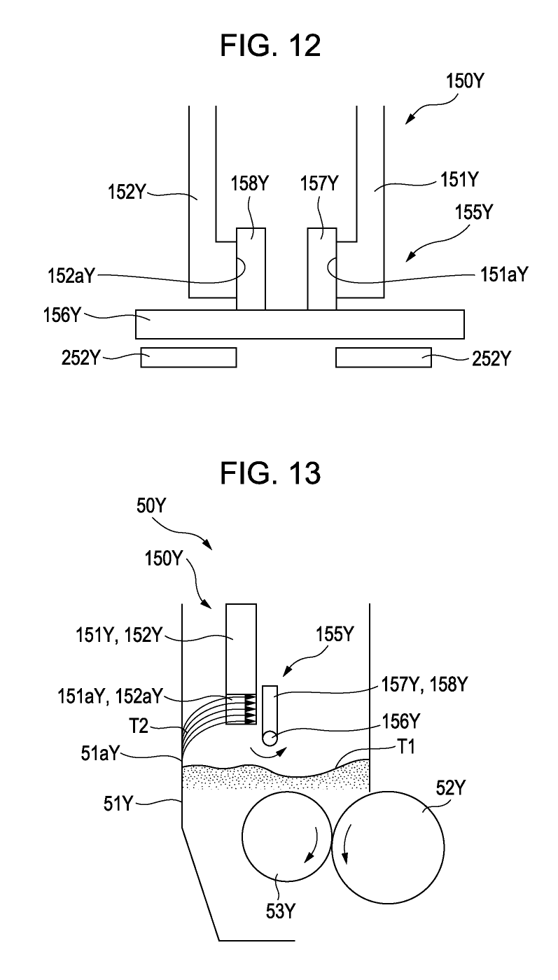

FIG. 12 is a drawing showing a fourth embodiment. The fourth embodiment includes toner flow restraining members 252Y configured to restrain the toner flow T2 below the light-receiving unit 152Y at a distance from the light-emitting unit 151Y of the toner level sensor 150Y for allowing the light-emitting surface cleaning member 157Y and the light-receiving surface cleaning member 158Y to pass therethrough. With the disposition of the toner flow restraining members 252Y, interruption of the toner flow T2 splashed back from an angle which causes the toner to be adhered on the light-emitting surface 151aY and the light-receiving surface 152aY, or reduction of contamination of the toner level sensor 150Y and the toner level sensor cleaning unit 155Y are enabled.

As shown in FIG. 13, the toner level sensor 150Y and the toner level sensor cleaning unit 155Y may be disposed in the opposite direction from those in the first embodiment. In other words, the splash-up member is disposed in the vicinity of the surface of the toner level T1 in the direction of the toner flow generated by the rotation of the toner supply roller 53Y. In this case, the direction of rotation of the toner supply roller 53Y is reversed (to counterclockwise in the drawing) from the first embodiment, the toner flow T2 is generated at the predetermined toner level T1.

Also, the light-emitting surface cleaning member 157Y and the light-receiving surface cleaning member 158Y may be configured to reciprocate within a part of the range.

In this manner, the developing device in this embodiment is characterized by comprising the developing roller 52Y configured to carry the toner, the toner supply roller 53Y configured to supply the developer to the developing roller, the developing chamber 51Y having the developing roller 52Y and the toner supply roller 53Y, the toner level sensor 150Y disposed above the toner level T1 in the developing chamber 51Y and configured to sense the toner flow T2, the developing device having high degree of sensing accuracy and high degree of durability is provided.

Since the splash-up member configured to splash the toner in the developing chamber 51Y upward and form the toner flow T2 is provided, the splash-up toner flow T2 is easily formed.

Since the splash-up member is the wall portion 51aY of the developing chamber 51Y, the low cost and the weight reduction are enabled by using an existing member.

Since the toner level sensor cleaning unit 155Y configured to clean the light-emitting unit 151Y and the light-receiving unit 152Y of the toner level sensor 150Y is provided, improvement of the accuracy of the toner level sensor 150Y is achieved.

Also, since the toner flow restraining members 252Y configured to restrain the toner flow T2 are provided below the toner level sensor 150Y, probability of splashing of the toner flow T2 on a portion other than the light-emitting unit 151Y and the light-receiving unit 152Y is reduced.

The toner level sensor 150Y is configured to determine the toner level T1 from a time length when the toner flow T2 is sensed during a predetermined period, so that the toner level T1 is determined easily.

In addition, since the image forming apparatus of this embodiment is characterized by including at least the photosensitive member 20Y on which the electrostatic latent image is formed, a developing device configured to develop the electrostatic latent image and form an image on the photosensitive member 20Y, and a transfer unit configured to transfer the image of the photosensitive member 20Y, and includes the developing cartridge 50Y mounted thereon, satisfactory image formation is achieved.

Also, the toner level sensor 150Y is disposed out of the image forming area, further satisfactory image formation is achieved.

The entire disclosure of Japanese Patent Application No. 2009-070168, filed Mar. 23, 2009 is expressly incorporated by reference herein.

What is claimed is:

1. A developing device comprising:
a developer carrier configured to carry toner;
a toner supply member configured to supply developer to the developer carrier;
a developing chamber having the developer carrier and the toner supply member; and
a sensing device disposed above a toner level in the developing chamber and configured to sense a toner flow.

2. The developing device according to claim 1, comprising a splash-up member configured to form a toner flow splashing upward by causing the toner in the developing chamber to flow.

3. The developing device according to claim 1, wherein the splash-up member is a wall portion of the developing chamber.

4. The developing device according to claim 1, wherein the splash-up member is a roller disposed out of an image forming area.

5. The developing device according to claim 1, comprising a sensing device cleaning unit configured to clean a sensing unit of the sensing device.

6. The developing device according to claim 1, comprising a toner flow restraining member configured to restrain the toner flow below the sensing device.

7. The developing device according to claim 1, wherein the sensing device determines a toner level by a time length in which the toner flow is sensed within a predetermined period.

8. An image forming apparatus comprising at least:
a latent image carrier on which an electrostatic latent image is formed;
a developing device configured to develop the electrostatic latent image and form an image on the latent image carrier;
a transfer unit configured to transfer the image on the latent image carrier, wherein
the developing device according to claim 1 is mounted as the developing device.
